(19) United States
(12) Patent Application Publication
(10) Pub. No.: US 2004/0003157 A1
(43) Pub. Date: Jan. 1, 2004

(54) Hot plug protection device for hard disk drives

(76) Inventor: Chun Liang Lee, Taipei (TW)

Correspondence Address: JACOBSON HOLMAN PLLC, 400 SEVENTH STREET N.W., SUITE 600, WASHINGTON, DC, 20004, US

(21) Appl. No.: 10/180,155

(22) Filed: Jun. 27, 2002

(51) Int. Cl. G06F 13/00

(52) U.S. Cl. 710/302

(57) ABSTRACT

A hot plug protection device for HDD's (Hard Disk Drive) is disclosed. The HDD herein refers to an IDE (Integrated Drive Electronics) HDD. The protection device is installed in the interface module of a computer-implemented apparatus. The protection device contains a power control module and an information control module. When the computer-implemented apparatus is working and one need to hot plug an IDE HDD, the power control module controls the instantaneous electrical power during the hot plug procedure. The information control module is further used to control the information transmissions between the IDE HDD and the computer-implemented apparatus. The invention achieves the objective of protecting both the HDD and the computer-implemented apparatus during the hot plug action thereby.

### BACKGROUND OF THE INVENTION

1. Field of Invention

The invention relates to a hot plug protection device and, in particular, to a hot plug protection device for IDE (Integrated Drive Electronics) HDD (Hard Disk Drive).

2. Related Art

Currently, information processing devices have been widely applied to all sorts of fields to help facilitating job processing. With continuous advance in the technologies, the information processing devices are more versatile in their functions. Aside from different functions for the user to manage data, the information processing devices also need sufficient space to store large volume of data.

As people become more dependent upon information processing devices, the functions on personal information processing devices often cannot satisfy the needs of enterprises. In order to meet the enterprise requirements, information processing devices need many extra functions and blade modules to form a server. However, when these blade modules are out of order or need to be replaced, it is impossible to turn off the whole server for replacing part of the blade modules. Therefore, the hot plug technology is developed to facilitate such tasks.

Although the hot plug technology is convenient, it still has some drawbacks. Taking an HDD as an example, connecting the HDD by hot plug results in instability of the server because the motor inside the HDD demands a larger current when it is turned on. If the server is functioning, manual replacement is likely to have incomplete insertion. The spike voltage due to the incomplete insertion often makes the server halt. This is even more likely to happen in ultra dense blade modules.

In conclusion, how to avoid the damages to the HDD and information processing device as a result of incomplete insertion of the HDD in the hot plug action is an important subject to be solved.

### SUMMARY OF THE INVENTION

In view of the foregoing, a hot plug protection device for HDD's is proposed. Its purpose is to prevent damages due to a spike voltage as a result of an incomplete hot plug action. The hot plug protection device for HDD's contains a power control module and an information control module. When the information processing device is functioning and one has to hot plug an IDE HDD, the power control module controls the instantaneous power during the hot plug. The information control module then controls the information transmissions between the IDE HDD and the information processing device, achieving the objective of protecting both the HDD and the information processing device during the hot plug action.

### BRIEF DESCRIPTION OF THE DRAWINGS

The invention will become more fully understood from the detailed description given hereinbelow illustration only, and thus are not limitative of the present invention, and wherein:

FIG. 1 is a schematic view of the structure of a hot plug protection device for HDD's;

FIG. 2 is a schematic view of the power control module in the hot plug protection device for HDD's; and

FIG. 3 is a schematic view of the steps for protecting an HDD during the hot plug action.

### DETAILED DESCRIPTION OF THE INVENTION

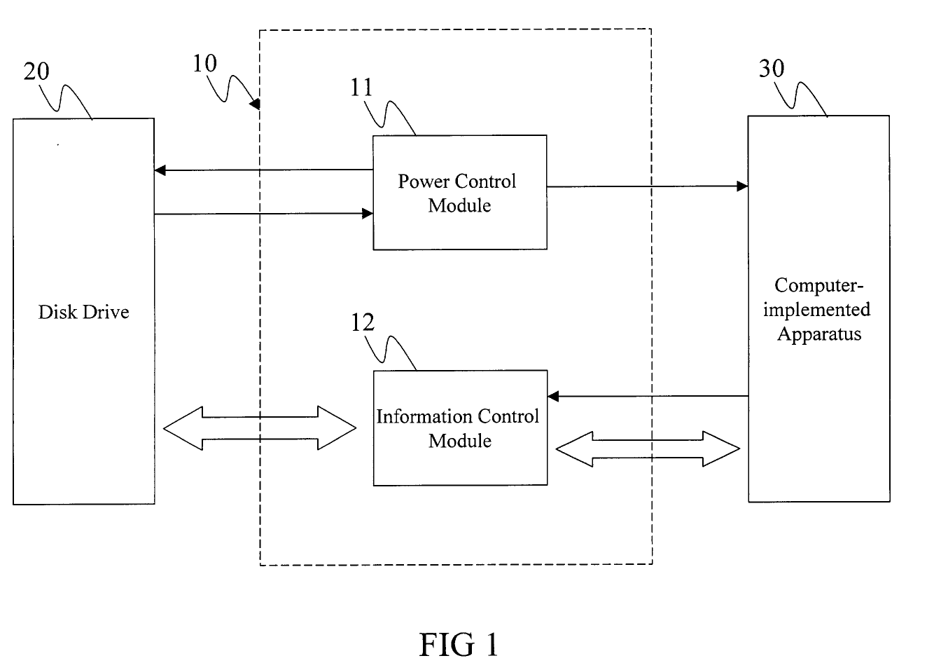

The invention discloses a hot plug protection device for HDD's (Hard Disk Drive). This protection device is installed inside an interface module. We first use FIG. 1 to explain the structure of the invention in detail.

The hot plug protection device for HDD's includes a power control module 11 and an information control module 12. The two control modules are installed in an ultra dense blade module 10. This ultra dense blade module 10 is provided with an installation signal and can be connected with a disk drive 20, which is an IDE (Integrated Drive Electronics) disk drive. The ultra dense blade module 10 is connected to a computer-implemented apparatus 30. When the power control module 11 and the disk drive 20 are connected, the power control module 11 detects the installation signal. Once the connection between the disk drive 20 and the ultra dense blade module 10 is completed, the power control module 11 sends a work voltage 5V to the disk drive 20. The information control module 12 is connected to the processing system 30 and is in charge of the signal transmissions between the processing system 30 and the disk drive 20. When the information control module 12 receives the enable signal sent out from the processing system 30, the information control module 12 is started so that the information in the processing system 30 and the disk drive 20 can be exchanged.

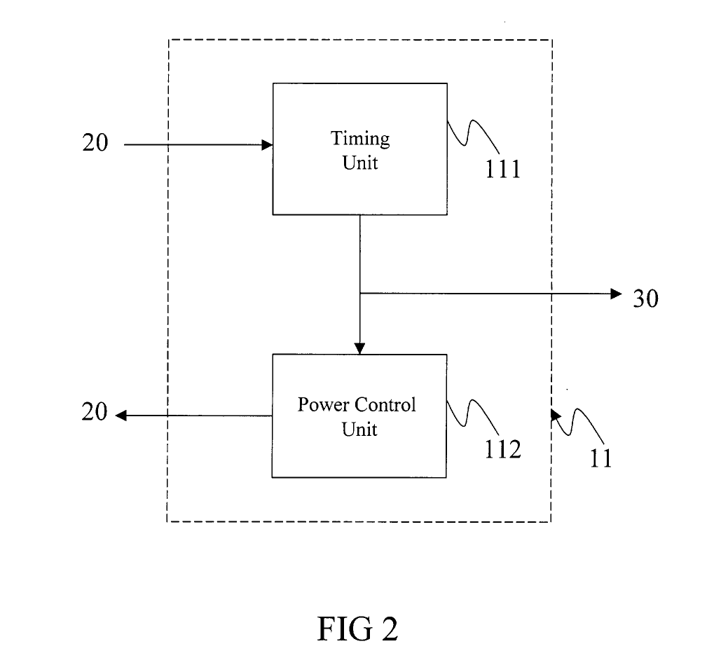

In the following paragraphs, we use FIG. 2 to illustrate the power control module of the disclosed hot plug protection device for HDD's.

The power control module 11 contains a timing unit 111 and a power control unit 112. The timing unit 111 is connected to the disk drive 20. After the timing unit 111 receives the installation signal, a present signal is generated to start the timing mechanism. The timing mechanism sends out a start signal to its output terminal when it reaches a predetermined time. The power control unit 112 is connected to the timing unit 111 and sends out the work voltage 5V to the disk drive 20 after receiving the start signal.

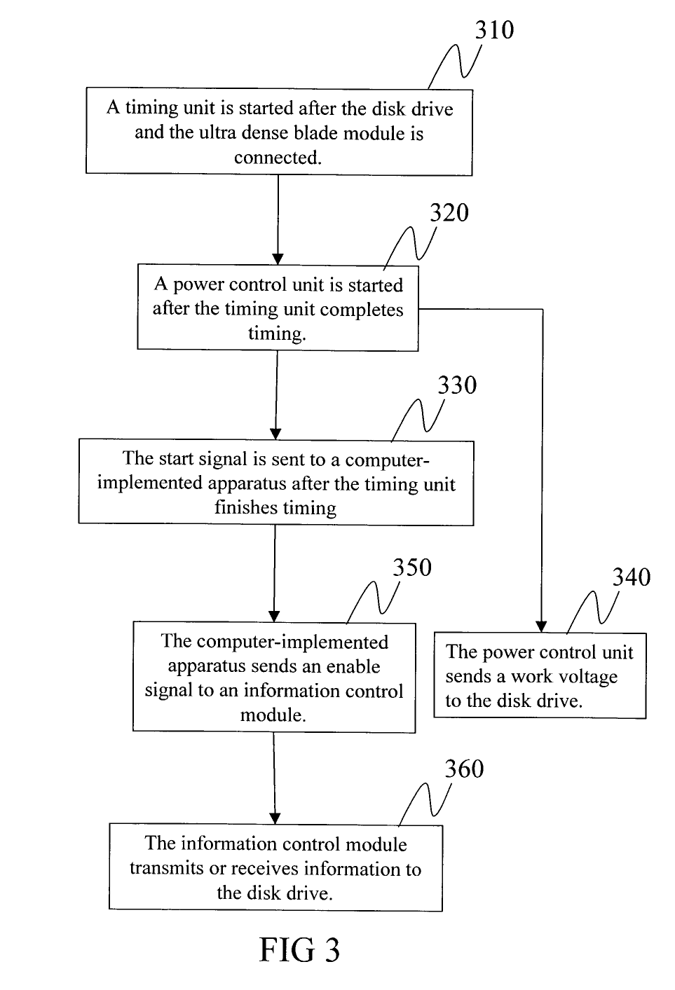

With reference to FIG. 3, the method of performing hot plug protection for HDD's includes the following steps.

1. A timing unit is started after the disk drive and the ultra dense blade module is connected (step 310). After an HDD is connected to the ultra dense blade module 10, a present signal is generated to trigger the timing mechanism of the timing unit. The timing unit is configured with a predetermined time.

2. A power control unit is started after the timing unit completes timing (step 320). After the timing mechanism counts the timing to the predetermined time, the timing unit sends out a start signal to the power control unit.

3. The start signal is sent to a computer-implemented apparatus after the timing unit finishes timing (step 330). In addition to the above-mentioned steps, the timing unit also sends out the start signal to the computer-implemented apparatus, notifying the computer-implemented apparatus of the completion of timing.

4. The power control unit sends a work voltage to the disk drive (step 340). After the power control unit receives the start signal, it sends out a work voltage 5V to the disk drive for the HDD to use. For protecting the HDD and maintaining the normal operations of the computer-implemented apparatus, the power control unit has to have the function of voltage slew rate control to prevent instantaneous spike voltages from happening.

5. The computer-implemented apparatus sends an enable signal to an information control module (step 350). After the computer-implemented apparatus receives the start signal, the computer-implemented apparatus sends an enable signal to the information control module for starting the information control module. The computer-implemented apparatus can also decide not to send out the enable signal and determine a later sending time.

6. The information control module transmits or receives information to the disk drive (step 360). The information control module includes a bus switch. When it receives the enable signal from the computer-implemented apparatus, the IDE bus between the information control module and the computer-implemented apparatus is employed to gauge the mutual communications between the disk drive and the computer-implemented apparatus.

In conclusion, the disclosed hot plug protection device for HDD's has the advantage of using the voltage slew rate control function to prevent spike voltages at the hot plug instant of inserting an IDE HDD into an ultra dense blade module. The above-mentioned installation signal further has an interlock function. As one of the advantages, it ensures that the interface module can be completely connected to the disk drive. This prevents the work voltage from damaging the disk drive and computer-implemented apparatus due to an incomplete connection.

What is claimed is:

1. A hot plug protection device for HDD's (Hard Disk Drive) implemented in an interface module, which is configured with an installation signal and through which the protection device is connected to a computer-implemented apparatus comprising:
a power control module connected to the HDD for detecting the connection between the HDD and the interface module and sending a work voltage to the HDD after receiving the installation signal; and
an information control module connected to the computer-implemented apparatus for receiving an enable signal sent out from the computer-implemented apparatus, transmitting the information on the computer-implemented apparatus to the HDD, and transmitting the information on the HDD to the computer-implemented apparatus.

2. The hot plug protection device of claim 1, wherein the power control module further comprises:
a timing unit used to detect the connection between the interface module and the HDD once the timing unit is connected to the HDD and starting a timing mechanism that sends out a start signal to an output terminal when the timing mechanism counts to a predetermined time; and
a power control unit connected to the timing unit for receiving the start signal and sending the work voltage to the HDD after receiving the start signal.

3. The hot plug protection device of claim 1, wherein the interface module is an ultra dense blade module.

4. The hot plug protection device of claim 1, wherein the HDD is an IDE HDD.

5. The hot plug protection device of claim 1, wherein an IDE bus is provided between the information control module and the computer-implemented apparatus for transmitting information.

6. The hot plug protection device of claim 1, wherein the information control module further comprises a bus switch for the data transmissions between the HDD and the computer-implemented apparatus.

7. The hot plug protection device of claim 2, wherein the start signal is further sent to the computer-implemented apparatus for notifying the computer-implemented apparatus of the current connection condition between the interface module and the HDD.

8. The hot plug protection device of claim 2, wherein the power control unit has a voltage slew rate control function.

9. The hot plug protection device of claim 1, wherein the installation signal contains an interlock function.

10. The hot plug protection device of claim 1, wherein a present signal is generated to start the timing mechanism when the interface module and the HDD are connected together.
